(19) United States
(12) Patent Application Publication
(10) Pub. No.: US 2009/0014649 A1
(43) Pub. Date: Jan. 15, 2009

(54) ELECTRON BEAM APPARATUS

(75) Inventors: Mamoru Nakasuji, Tokyo (JP); Nobuharu Noji, Tokyo (JP); Tohru Satake, Tokyo (JP); Toru Kaga, Tokyo (JP); Hirosi Sobukawa, Tokyo (JP); Takeshi Murakami, Tokyo (JP); Tsutomu Karimata, Tokyo (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: EBARA CORPORATION, Tokyo (JP)

(21) Appl. No.: 11/909,409

(22) PCT Filed: Mar. 22, 2006
(86) PCT No.: PCT/JP2006/305688

§ 371 Date: Sep. 4, 2008

(30) Foreign Application Priority Data
Mar. 22, 2005 (JP) 2005-080989
Mar. 28, 2005 (JP) 2005-091514
Mar. 28, 2005 (JP) 2005-092273

(51) Int. Cl. G01N 23/00

(52) U.S. Cl. 250/310

(57) ABSTRACT

Secondary electrons emitted from a sample (W) by an electron beam irradiation is deflected by a beam separator (77), and is deflected again in a perpendicular direction by an aberration correction electrostatic deflector (711) to form a magnified image on the principal plane of an auxiliary lens (712). The secondary electron beam diverged from the auxiliary lens (712) passes through axial chromatic aberration correction lenses (714-717) and images on a principal plane of an auxiliary lens (718) for a magnifying lens (719). The magnified image is formed in a position spaced apart from the optical axis. Therefore, when the secondary electron beam diverged from the auxiliary lens (712) is incident on the axial chromatic aberration correction lenses without any change, large abaxial aberration occurs. To avoid it, the auxiliary lens (712) is used to form the image of an NA aperture (724) in substantially a middle (723) in the light axis direction of the axial chromatic aberration correction lenses (714-717).

### TECHNICAL FIELD

The present invention relates to an electron beam device. More particularly, the present invention relates to an electron beam device, which irradiates a sample with an electron beam and detects with a detector, electrons emitted from the sample upon irradiation of the sample with the electron beam, whereby evaluation of defects and the like of the sample can be achieved with high throughput and reliability.

### BACKGROUND ART

Factors which may significantly limit precision of evaluation of a sample when using an electron beam device are caused by axial chromatic aberrations and spherical aberrations.

There is used with respect to an SEM electron beam device, and a transmission electron microscope (TEM), a device having a Wien filter and/or a quadrupole lens, which is capable of correcting axial chromatic aberration.

There is also used an electron beam device in which an electrostatic lens is used as an objective lens, and a high voltage is applied to electrodes of the electrostatic lens to control the lens and thereby reduce axial chromatic aberration and spherical aberration. There has been proposed as such an electron beam device a device for correcting axial chromatic aberration in an axially-symmetric lens in which there is provided an axial chromatic aberration correction lens, and which includes four stages of quadrupole lenses and two stages of quadrupole magnetic lenses, so as to obtain a super-high-resolution image.

Further, there is known an electron beam device having a structure such that electrons emitted from an electron gun are converted into a multibeam through a plurality of aperture portions, a reduced image of the multibeam is formed on a sample, a multibeam of secondary electrons emitted from the sample is magnified, and the magnified multibeam is detected by a plurality of detectors.

Still further, there is known an electron beam device using a mapping projection type electronic optical system which is adapted to irradiate a sample with an electron beam that is formed to be rectangular in shape.

### DISCLOSURE OF THE INVENTION

### Problems to be Solved by the Invention

As described above, with respect to the SEM and the TEM, means for correcting axial chromatic aberration have been proposed and put to practical use. This is a result of the fact that axial chromatic aberration can be relatively easily reduced using an axial chromatic aberration correction lens, because an axial chromatic aberration coefficient is a small value of, for example, 1 mm to 100 mm.

In contrast, in an electron beam device using a mapping projection type electronic optical system an axial chromatic aberration coefficient is a relatively large value, of several 10 mm to several m, and it is therefore required that a length of an axial chromatic aberration correction lens be made large. When a multipole lens is used for axial chromatic aberration correction, it is necessary to set the Bohr radius of the multipole lens to an extremely small value. As a result, an interelectrode distance becomes shorter, which causes a problem in that it is not possible to avoid discharge between electrodes.

Accordingly, it is not preferable that a technique for a conventional SEM electron beam device be applied to an electron beam device in which a mapping projection type electronic optical system is used to correct axial chromatic aberration. In an electron beam device using the mapping projection type electronic optical system, aberration caused by the electronic optical system can be not be analyzed sufficiently. Thus, a suitable system has not yet been proposed which is capable of correcting different types of aberration most effectively.

Further, a conventional method of correcting axial chromatic aberration is to obtain an ultra-high resolution of 1 nm to 0.1 nm. In contrast, when a semiconductor wafer is to be evaluated, a sufficient resolution is approximately 20 nm to 100 nm. However, a beam current used for it is required to be increased. In order to increase the beam current, it is necessary to increase a numerical aperture (NA). When the NA is small, aberration generally includes axial chromatic aberration. When the NA becomes larger, axial chromatic aberration increases proportionally, and spherical aberration increases proportionally to the third power of the NA. Therefore, when the NA is increased to increase the beam current, spherical aberration becomes larger than axial chromatic aberration, and it is essential to correct spherical aberration.

In a system for applying a high voltage to an electrostatic lens used as the objective lens for correcting axial chromatic aberration and spherical aberration, an electric field on a surface of a sample is increased by application of high voltage. However, a possibility exists that a discharge will be generated between the electrostatic lens and the sample, thereby damaging the sample. When the axial chromatic aberration correction means including the four stages of quadrupole lenses is used, it is difficult to set the axial chromatic aberration of the optical system of the electron beam device to a predetermined value, which gives rise to a problem that an absolute value of axial chromatic aberration of the axial chromatic aberration correction means is not made equal to that of axial chromatic aberration corrected by another optical system, thereby resulting in an increasing residual chromatic aberration.

The axial chromatic aberration correction lens including the four stages of quadrupole lenses and the two stages of quadrupole magnetic lenses has an excellent aberration characteristic in the vicinity of an optical axis. However, a characteristic of abaxial aberration (or off-axis aberration) in a region spaced apart from the optical axis is not as good. Therefore, a problem arises in that abaxial aberration is caused in a region spaced apart from the optical axis.

Any system has not been provided in which a large current can be used by correcting of axial chromatic aberration to employ a large NA aperture.

The multibeam type electron beam device requires precision adjustment of a beam interval and an angle (rotational angle) formed between a beam arrangement direction and a reference coordinate axis of the electron beam device. However, to date a method of evaluating beam interval and rotational angle has not been proposed, and a problem therefore exists that a beam interval and rotational angle cannot be precisely adjusted.

The present invention has been accomplished in view of the problems of the conventional art, and an object of the present invention is to provide an electron beam device using an axial chromatic aberration correction lens in which abaxial aberration caused by an axial chromatic aberration correction lens can be effectively corrected.

Another object of the present invention is to provide a multibeam type electron beam device in which a beam interval and an angle formed between a beam arrangement direction and a reference coordinate axis of the electron beam device can be precisely and easily evaluated using a low-cost means.

Another object of the present invention is to provide an electron beam device using a mapping projection type electronic optical system in which aberration other than axial chromatic aberration is reduced, and axial chromatic aberration can be sufficiently reduced even when a length of an axial chromatic aberration correction means is shortened and an inner diameter thereof is lengthened.

Another object of the present invention is to prevent, even when a high voltage is applied to an electrostatic lens used as an objective lens in order to reduce axial chromatic aberration and spherical aberration, discharge between the electrostatic lens and a sample, to thereby prevent the sample from being damaged.

Another object of the present invention is to perform adjustment such that an absolute value of axial chromatic aberration of an electronic optical system such as an objective lens becomes equal to that of axial chromatic aberration of a correction lens for axial chromatic aberration of the electronic optical system.

### Means for Solving the Problems

In order to achieve the above-mentioned objects, the present invention provides an electron beam device for irradiating a sample with an electron beam and detecting electrons emitted from the sample to obtain information on the sample, including, multiple stages of multipole lenses, with an auxiliary lens being provided on an incident side of the multiple stages of multipole lenses, and an image plane being formed in an inner surface of the auxiliary lens.

The electron beam device according to the present invention mentioned above is preferably constructed such that a visual field is divided into a plurality of sub-visual fields to repeat irradiation of a primary electron beam and detection of a secondary electron beam for each of the sub-visual fields; and an axial chromatic aberration correction lens is included in a magnifying optical system contained in a secondary optical system. Preferably the electron beam device further includes means for forming a primary electron beam to be a rectangular shape, which means is included in a primary electron optical system.

Preferably, the electron beam device according to the present invention further includes means for irradiating the sample with a primary electron beam as a multibeam, which means is included in a primary electron optical system, detecting means including a plurality of detectors for detecting a plurality of secondary electron beams containing the electrons emitted from the sample, and multibeam evaluation means for evaluating a rotational angle between an arrangement direction of the multibeam and a reference coordinate system of the electron beam device and a beam interval of the multibeam.

In such a case, it is preferred that an axial chromatic aberration correction lens and the auxiliary lens be included in the primary electron optical system. Further, it is preferred that the multibeam evaluation means perform evaluation based on an interval between signals obtained by the plurality of detectors when markers provided parallel to a y-axis (y-axis is a stage continuous moving direction) of the reference coordinate system are scanned in an x-axis direction.

### EFFECTS OF THE INVENTION

According to the present invention, the above-mentioned structure is employed, and the following advantages are obtained.

The auxiliary lens is provided in the image plane located on the incident side of the axial chromatic aberration correction lens, so that abaxial aberration caused by the axial chromatic aberration correction lens can be reduced. Therefore, it is possible to obtain high-precision image data whose aberration is reduced.

In the multibeam type electron beam device, regardless of whether the angle formed between the beam arrangement direction and the reference coordinate axis is appropriate, and regardless of whether the beam interval is equal to a predetermined value can be evaluated based on an interval between the obtained signals, so that the angle and the beam interval can be precisely adjusted.

### BRIEF DESCRIPTION OF THE DRAWINGS

FIG. 1 is an explanatory diagram showing an electron beam device according to a first embodiment of the present invention;

FIG. 2 is a cross sectional view showing a structure of a Wien filter included in the electron beam device of FIG. 1;

FIG. 3 is a graph showing aberration characteristics in a magnifying optical system;

FIG. 4 is an explanatory diagram showing an electron beam device according to a second embodiment of the present invention;

FIG. 5 is a cross sectional view showing a structure of a Wien filter included in the electron beam device of FIG. 4;

FIG. 6 is an explanatory diagram showing an electron beam device according to a third embodiment of the present invention;

FIG. 7 is an explanatory diagram showing an electron beam device according to a fourth embodiment of the present invention;

FIG. 8 is an explanatory diagram showing a means for obtaining image data from an EBCCD in the electron beam device of FIG. 7;

FIG. 9 is an explanatory diagram showing an electron beam device according to a fifth embodiment of the present invention;

FIG. 10 is an explanatory view for explaining evaluations of a rotational angle between a multibeam arrangement direction and an x-y coordinate axis and of a beam interval of the multibeam in the electron beam device of FIG. 9;

FIG. 11 is an explanatory diagram showing an electron beam device according to a sixth embodiment of the present invention; and

FIG. 12 is a cross sectional view showing a structure of a Wien filter included in the electron beam device of FIG. 11.

### BEST MODE FOR CARRYING OUT THE INVENTION

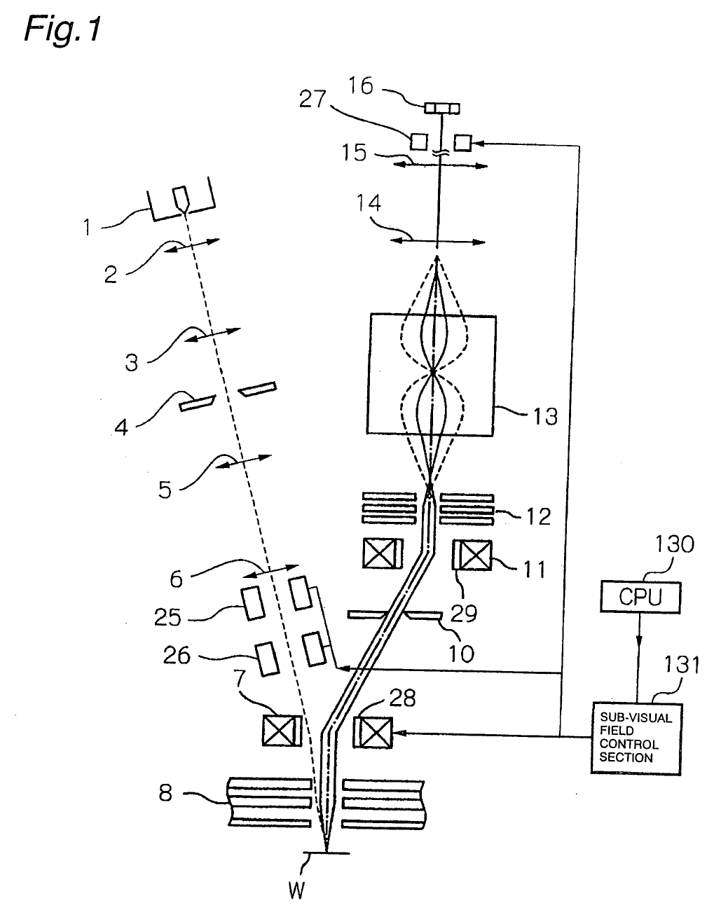

FIG. 1 shows a principal part of an electron beam device using a mapping projection type electronic optical system according to a first embodiment of the present invention. In the electron beam device, an irradiation region size and an irradiation current density of an electron beam emitted from an electron gun 1 are adjusted by two stages of condenser lenses 2 and 3. The electron beam is formed to rectangular by a rectangular aperture 4 which is square or rectangular in shape. The magnification of a shaped rectangular primary electron beam is adjusted by two stages of irradiation lenses 5 and 6. A sub-visual field within a rectangular visual field on a sample W is irradiated with the electron beam passing through a beam separator 7 and an objective lens 8. The visual field on the sample W is divided into, for example, nine sub-visual fields arranged in a scanning direction of the primary electron beam. Selecting the sub-visual fields is performed by electrostatic deflectors 25 and 26. Irradiation of the primary electron beam and the acquisition of image data based on a detected secondary electron beam are performed for each sub-visual field unit.

In order to prevent the primary electron beam from affecting the secondary electron beam, the electron beam device is designed such that a path of the primary electron beam is different from a path of the secondary electron beam, even after the primary electron beam passes through the beam separator 7.

The secondary electron beam emitted from the sample W is accelerated and focused by an acceleration electric field generated by a positive voltage applied to the objective lens 8 and a negative voltage applied to the sample W, to be converted into a thin parallel beam. As shown in FIG. 1, the parallel beam is deflected by the beam separator 7 in a left direction. After that, an angular aperture is limited by an NA opening 10 and the beam is deflected by an electromagnetic deflector 11 in a perpendicular direction in the drawing. The deflected beam is focused by an auxiliary lens 12 to produce a reduced image. Then, axial chromatic aberration and spherical aberration are corrected by a Wien filter 13 and the beam is imaged onto and detected by one of nine CMOS image sensors included in a CMOS image sensor unit 16 through two stages of magnifying lenses 14 and 15. Therefore, an electrical signal including information on the sample is obtained. The nine CMOS image sensors are arranged in three columns and three rows and are successively selected by an electrostatic deflector 27. Because the nine CMOS image sensors are provided, in the case of CMOS image sensors which require a data readout time equal to or less than nine times the time for irradiating each sensor, time loss in data readout can be avoided.

A secondary electron beam emitted from a sub-visual field spaced apart from an optical axis is deflected by electrostatic deflectors 28 and 29 so as to be aligned with the optical axis.

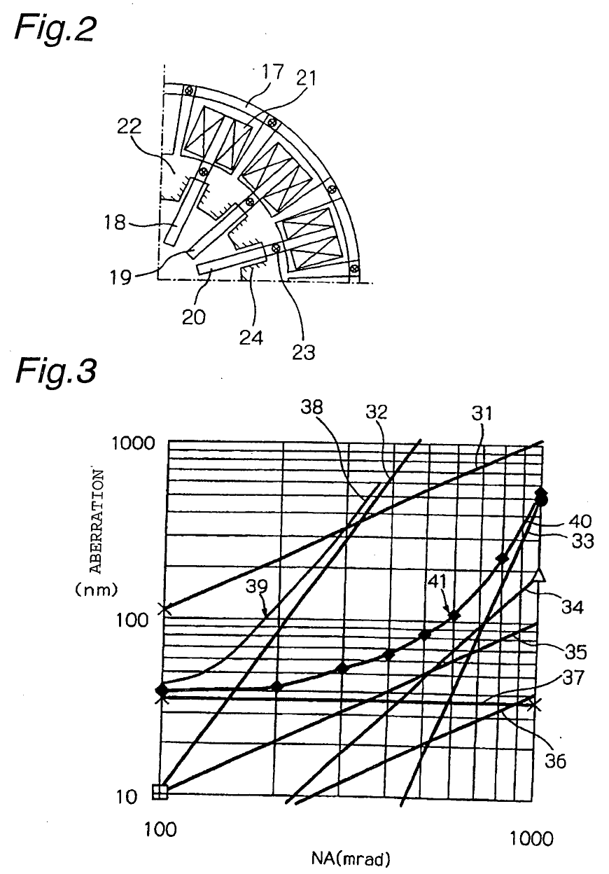

FIG. 2 shows a cross sectional structure of the Wien filter 13 for correcting axial chromatic aberration and spherical aberration, though it shows only ¼ of the structure. The Wien filter 13 is manufactured as follows:

Permalloy plates 18 to 20 for electrodes and a permalloy cylinder 17 for yoke are prepared and fixed to an insulating spacer 22 by screws 23.

The permalloys are heat-treated for annealing.

Coils 21 for generating magnetic fields for correction are wound around the permalloy plates 18 to 20.

Ends of the permalloy plates 18 to 20 and an end of the permalloy cylinder 17 are processed by wire cutting at high precision.

In the insulating spacer 22, a surface excluding a beam irradiatable surface and a surface necessary to maintain insulation is coated with gold.

In order to correct axis chromatic aberration of an axially-symmetric lens system, it is necessary to adjust the axis chromatic aberration of the axially-symmetric lens system and axis chromatic aberration of the Wien filter 13 such that +/−signs are reversed to each other, and absolute values are equal to each other. In order to precisely make the absolute values equal to each other, an excitation voltage provided to the auxiliary lens 12 is adjusted. When an axis chromatic aberration of the Wien filter 13 is small, the excitation voltage of the auxiliary lens 12 is adjusted such that the secondary electron beam travels on a path as indicated by the broken line in FIG. 1, thereby making the absolute value of the axis chromatic aberration of the Wien filter 13 and the absolute value of the axis chromatic aberration of the axially-symmetric lens system equal to each other.

When the auxiliary lens 12 and the Wien filter 13 are used, an axial chromatic aberration coefficient of the objective lens can be significantly reduced. A length of the Wien filter 13 can be shortened, and an optical path length of the electron beam device can be relatively reduced. An inner diameter of the Wien filter 13 is increased, so that an interelectrode distance can be relatively lengthened, and it is thereby possible to prevent undesirable discharge between electrodes.

The reason why the axial chromatic aberration coefficient of the objective lens 8 can be significantly reduced is as follows.

When the axial chromatic aberration of the objective lens 8 is to be corrected by the Wien filter, it is necessary to adjust a negative axial chromatic aberration coefficient Cax(wf) generated by the Wien filter and an axial chromatic aberration coefficient Cax(image) at an image point formed by the object lens such that absolute values are equal to each other and +/−signs are reversed to each other. An axial chromatic aberration coefficient Cax(object) at an object point of the object lens (point on sample) can be substantially determined when a size of an optical system in Z-axis (Optical axis) direction is set. The axial chromatic aberration coefficient Cax(image) can be expressed as follows.

Cax(image)=M2(f(wf)/f(SE))3/2Cax(object)

where M indicates a magnification from the object point to the image point, f(wf) indicates an electron beam energy at the time of passing through the Wien filter, and f(SE) indicates an initial energy of the secondary electron (energy on sample surface).

As is apparent from the above expression, when the magnification M is set to a small value, Cax(image) can be reduced. Therefore, the axial chromatic aberration coefficient of the objective lens can be reduced.

Since the Wien filter includes dodecapoles as shown in FIG. 2, it is possible to generate a dipole electric field, a dipole magnetic field, a quadrupole electric field, a quadrupole magnetic field, a sextupole electric field, and a sextupole magnetic field. A Wien condition (which is a condition that an electron beam travels straight) can be satisfied by dipole electric and magnetic fields. Thus, axial chromatic aberration can be corrected by quadrupole electric and magnetic fields, and spherical aberration can be corrected by sextupole electric and magnetic fields. Therefore, the spherical aberration can be corrected together with the correction of the axial chromatic aberration.

In the electron beam device shown in FIG. 1, when the objective lens 8 is MOL(Tilting and Moving Objective Lens)-operated, not as the electrostatic lens but rather as the electromagnetic lens, aberration at a time of movement of a sub-visual field can be reduced. Various other modifications can also be made.

FIG. 3 shows a result obtained by simulation of aberration characteristics in the objective lens 8 and the auxiliary lens 12 as shown in FIG. 1. When an NA aperture value is equal to or smaller than 310 mrad (milliradian), the axial chromatic aberration (Graph 31) is larger than the spherical aberration (Graph 32). However, when the NA aperture value is equal to or larger than 310 mrad, the spherical aberration becomes larger. When only the axial chromatic aberration is corrected by the Wien filter, the aberration characteristic becomes as shown in Graph 38. Therefore, in order to obtain a blur of 100 nm, it is necessary to set the NA to a value equal to or smaller than 190 mrad. When both the axial chromatic aberration and the spherical aberration are corrected, residual-aberration is as shown in Graph 40. Therefore, in order to obtain the blur of 100 nm, the NA can be increased up to 590 mrad.

In the case of 190 mrad, a secondary electron (SE) transmittance of only 3.57% can be obtained. However, in the case of 590 mrad, a transmittance of 30.9% is obtained, and corresponds to a value close to ten times that in the case of 190 mrad. Therefore, as will be apparent from such a result, by correcting the axial chromatic aberration and also the spherical aberration in the electron beam device using the mapping projection type electronic optical system, performance of the system is significantly improved.

In FIG. 3, Graph 33 shows quinary spherical aberration, Graph 34 shows coma aberration, Graph 35 shows tertiary axial chromatic aberration, Graph 36 shows quaternary axial chromatic aberration, Graph 37 shows chromatic aberration of magnification, Graph 39 shows an NA aperture value in a case where a blur equal to or smaller than 100 nm is obtained when only axial chromatic aberration is corrected, and Graph 41 shows an NA aperture value in a case where a blur equal to or smaller than 100 nm is obtained when axial chromatic aberration and spherical aberration are corrected.

According to the electron beam device of the first embodiment, aberration other than axial chromatic aberration (in particular, spherical aberration) can be reduced. Even when a length of the axial chromatic aberration correction means is shortened and the inner diameter thereof is lengthened, axial chromatic aberration can be sufficiently reduced, and a length of the Wien filter can be accordingly shortened. As a result, an optical path length of the electron beam device can be relatively reduced. The inner diameter of the Wien filter is increased, so an interelectrode distance can be relatively lengthened, so that it is possible to prevent undesirable discharge between electrodes.

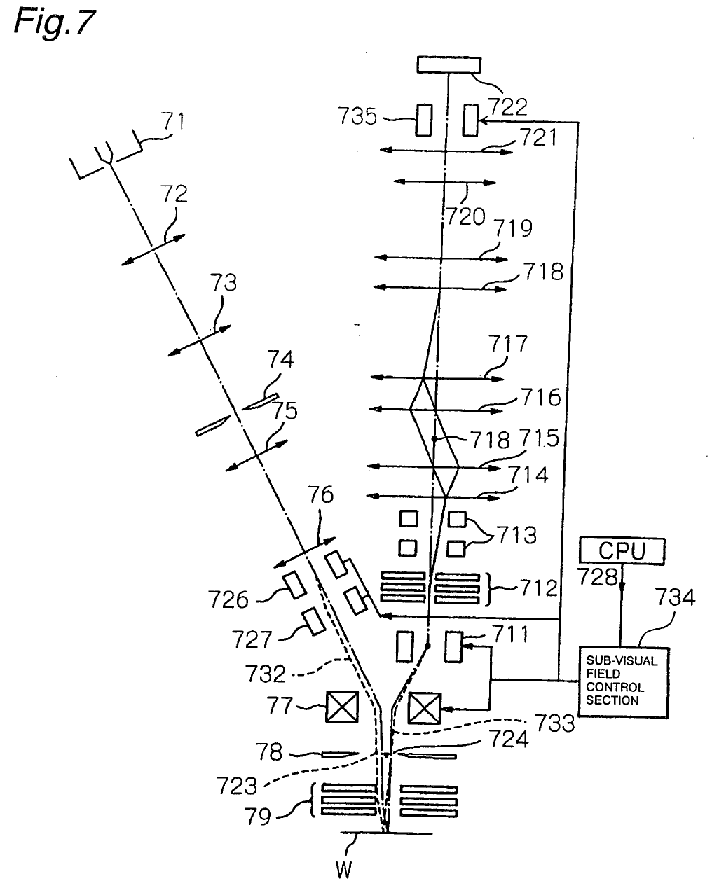

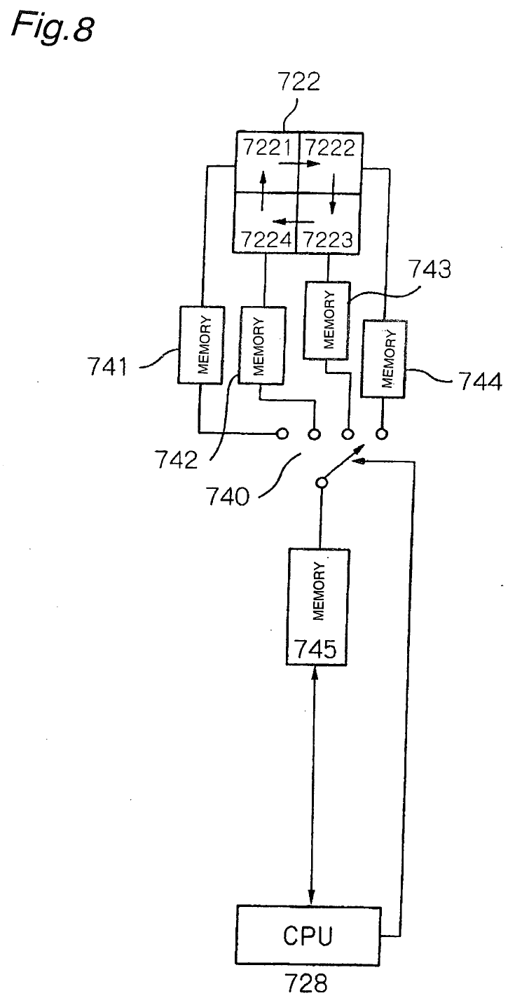

In FIG. 1, the reference numeral 30 denotes a CPU controlling the operation of the electron beam device, and 31 denotes a sub-visual field control unit which is a variable voltage source. A structure can be employed in which the visual field is divided into a plurality of sub-visual fields to repeat the irradiation of the primary electron beam and the detection of the secondary electron beam for each of the sub-visual fields. Control with respect to the sub-visual fields will be described later with reference to FIGS. 7 and 8. A variable voltage source(s) for supplying predetermined voltages to predetermined other elements of the electron beam device under the control of the CPU 30 is also provided, but is omitted from FIG. 1 for simplification. The same omission is made from the descriptions of the embodiments described later.

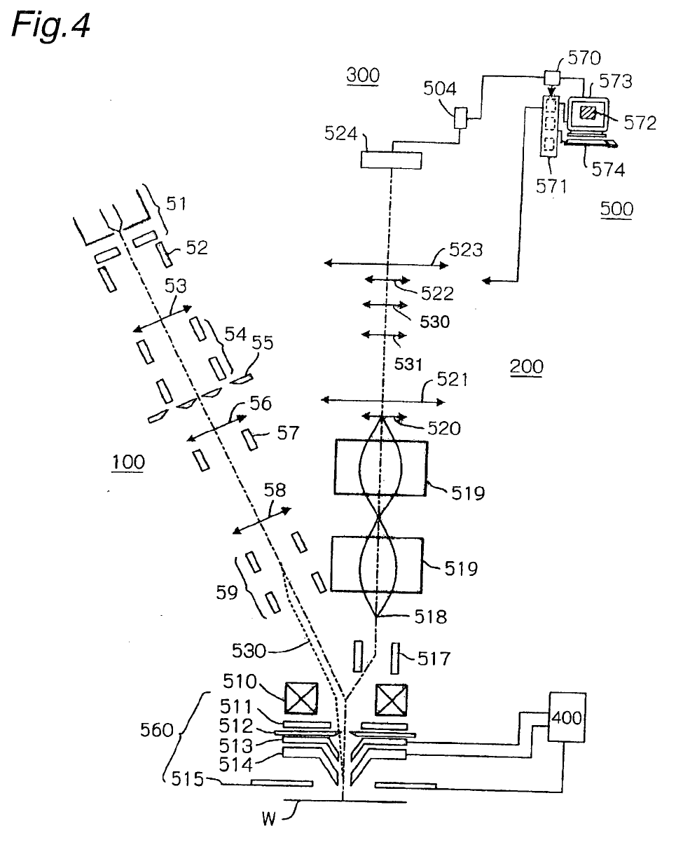

FIG. 4 shows an electron beam device according to a second embodiment of the present invention. The electron beam device uses a mapping projection type electronic optical system and includes a primary electron optical system 100 for forming a rectangular beam from an electron beam emitted from an electron gun 51 and focusing the rectangular beam on the sample W, a secondary electron optical system 200 for magnifying an image of secondary electrons emitted from a surface of the sample W, a detection device 300 for detecting the secondary electrons injected from the secondary electron optical system, a voltage control power supply 400 which is a variable voltage source, and a control device 500 for controlling the entire electron beam device.

The primary electron optical system 100 includes the electron gun 51 having an LaB6 cathode for emitting a primary electron beam, a condenser lens 53 for focusing the primary electron beam emitted from the electron gun 51, a shaping aperture portion 55 for shaping the focused primary electron beam to form the rectangular beam, shaping lenses 56 and 58 for finely adjusting a reduction ratio of the rectangular beam, axis alignment deflectors 52, 54, and 57 for performing axis alignment of the primary electron beam, a primary electron beam path control deflector 59 for causing the primary electron beam to travel on a path different from the secondary electron path, and an objective lens 560 for irradiating the sample W with the focused primary electron beam. A voltage is supplied from the voltage control power supply 500 to the objective lens 560. Therefore, according to the primary electron optical system, control is performed such that the rectangular beam is formed from the primary electrons emitted from the electron gun 51 having the LaB6 cathode, is focused on the sample W, and is caused by the primary electron beam path control deflector 59 to travel on the path (indicated by a broken line 530) different from the secondary electron path.

The secondary electron optical system 200 includes an electrostatic deflector 517. Chromatic aberration of deflection which is caused by the electromagnetic deflector 10 for separating electrons which are emitted from the sample W and accelerated by the objective lens 560 from the primary electron optical system is corrected by the electrostatic deflector 517. The secondary electron optical system 200 further includes a chromatic aberration correction lens 519 which causes negative axial chromatic aberration, an auxiliary lens 520 provided in a position of a magnified image of the secondary electrons which is formed by the chromatic aberration correction lens 519, a magnifying lens 521 for further magnifying a secondary electron image, an auxiliary lens 522 provided in a position of a magnified image of the secondary electrons which is formed by the magnifying lens 521, and a final magnifying lens 523. Therefore, according to the secondary electron optical system, the secondary electron beam emitted from the sample W is magnified and imaged onto a micro channel plate (MCP) 524 of the detection device 300.

An electromagnetic deflector 510 for an electron beam separator can be included in the primary electron optical system 100, or it can be included in the secondary electron optical system 200. Alternatively, the electromagnetic deflector 510 can be commonly included in both the primary electron optical system 100 and the secondary electron optical system 200.

The detection device 300 includes the MCP 524 and a TDI (Time Delay Integration) camera 504. The TDI camera 504 converts the secondary electron image formed onto the MCP 524 into an electrical signal and transmits the signal to the control device 500.

The objective lens 560 includes a disk-shaped axially-symmetric electrode 515, an electrode 514, an electrode 513, an NA aperture 512, and an electrode 511, which are disposed in order from the sample W side. Each of the electrode 514 and the electrode 513 includes a cone-shaped optical axis vicinity electrode whose radius becomes smaller with a reduction in distance at the sample W side. In this embodiment, although the disk-shaped axially-symmetric electrode 515 is formed to be disk shaped, it may be formed to be cone shaped. The electrode 511 may be omitted.

The voltage control power supply 400 applies a positive high voltage to the electrode 514 in order to focus the primary electron beam and reduce the axial chromatic aberration and the spherical aberration. The voltage control power supply 400 applies a voltage close to a ground voltage to the axially-symmetric electrode 515. Then, a high electric field generated by the application of the positive high voltage to the electrode 514 is blocked by the electrode 515, so that an electric field strength on the sample W is suppressed to a small value. Consequently, electrical breakdown on the surface of the sample does not occur, thereby preventing discharge between the electrode 514 and the sample W. At this time, the high voltage is applied to the electrode 514, so the axial chromatic aberration of the objective lens 560 can be held to a small value.

In order to improve substrate evaluation precision of the electron beam device, it is necessary to make an absolute value of positive axial chromatic aberration caused by the objective lens 560 equal to an absolute value of the negative axial chromatic aberration caused by the chromatic aberration correction lens 519. Therefore, when the assembly precision of the electronic optical system is set to a required value and a voltage applied to the electrode 515 of the objective lens 560 is adjusted by the voltage control power supply 400, or when both the voltage applied to the electrode 515 and the voltage applied to the electrode 514 are adjusted, a value of the axial chromatic aberration can be precisely adjusted. For example, when the voltage applied to the electrode 515 increases, the voltage applied to the electrode 514 at the same focal length is increased because it is necessary to hold an electric field between the electrode 515 and the electrode 514 at a constant value in order to obtain the same lens action. As a result, the axial chromatic aberration becomes smaller. In contrast, when the voltage applied to the electrode 515 is reduced, the voltage applied to the electrode 514 is also reduced because it is necessary to hold the electric field between the electrode 515 and the electrode 514 at the constant value in order to obtain the same lens action. As a result, the axial chromatic aberration becomes larger.

Therefore, when residual chromatic aberration of the electron beam device is reduced, an angular aperture of the NA opening 512 can be set to a value of approximately 400 mrad (milliradian) larger than a normal value of 200 mrad (milliradian), with the result that the secondary electron transmittance becomes larger. Thus, a large beam current can be obtained, and the sample can be evaluated at high throughput.

The electrode 513 has a potential close to an earth voltage. When the potential is changed by several 10V, a focal deviation caused by upward and downward movement (variation in Z-axis direction) of the sample W can be dynamically corrected. The cone shape of the electrode 513 corresponds to the shape of the electrode 514, so that a required focal length can be obtained without separating the electrodes from each other in the vicinity of the optical axis.

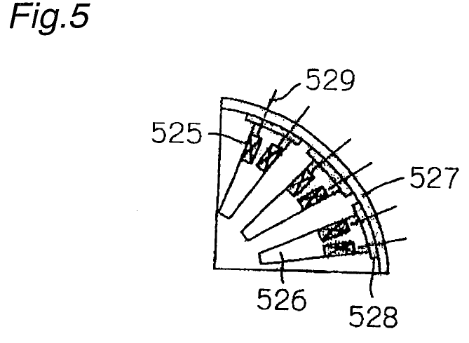

The chromatic aberration correction lens 519 includes two stages of Wien filters. An image is temporarily formed in a middle point between the two stages of Wien filters so that the path shown in FIG. 4 is obtained. FIG. 5 shows only a ¼ cross section of the Wien filter. As shown in FIG. 5, the Wien filter includes a 12-pole electrode 526 made of permalloy and employs a structure in which currents are supplied to coils 525 wound around the electrodes to generate magnetic fields. When voltages for generating electric fields are applied to the electrode 526 to cause excitation currents for generating two-time symmetric magnetic fields in a two-time (rotational) symmetric structure, that is, in a structure in which a symmetric arrangement is made two times (at 180 degrees and 360 degrees) in the case where the electrode 526 is rotated while a potential relationship among the respective poles thereof is maintained, a Wien condition, that is, a condition where secondary electrons travel on a straight path is satisfied. Voltages for generating four-time symmetric electric fields and voltages for generating six-time symmetric electric fields are superimposed on each other and applied to the electrodes. Excitation currents for generating four-time symmetric magnetic fields and six-time symmetric magnetic fields are supplied to the coils. The four-time symmetric electric fields and magnetic fields cause negative axial chromatic aberration. The six-time symmetric electric fields and magnetic fields cause negative spherical aberration. In the objective lens 560 of the electron beam device, when the NA aperture is approximately 200 mrad, the aberration mostly consists of axial chromatic aberration. However, when the NA aperture is equal to or larger than 400 mrad, a value of the spherical aberration becomes larger, and it is therefore important to correct the spherical aberration.

The electron gun 51 including the LaB₆ cathode operates in a spatial charge limit condition and has a small shot noise. The primary electrons emitted from the electron gun 51 are focused by the condenser lens 53 to irradiate apertures of the shaping aperture portion 55 at a uniform strength. The primary electron beam is shaped by the aperture of the shaping aperture portion 55 to form the rectangular beam. The rectangular beam is reduced by the shaping lenses 56 and 58 and deflected by the electromagnetic deflector 510, to be incident on the objective lens 560. The primary electron beam is axis-aligned by the axis alignment deflectors 52, 54, and 57. The primary electron beam is reduced by the objective lens 560 to be focused on the sample W. As described above, when the positive high voltage is applied to the electrode 514 and the voltage close to the ground voltage is applied to the axially-symmetric electrode 515, the axial chromatic aberration of the objective lens 560 can be held to a small value, while discharge between the electrode 514 and the sample W is prevented. The primary electron beam is controlled such that it travels on the path different from the secondary electron path by the primary electron beam path control deflector 59. Therefore, space charges of the primary electrons do not affect the secondary electrons.

The secondary electron beam emitted from the sample W is accelerated by an accelerating electric field generated between the positive voltage of the objective lens 560 and the sample W. The secondary electron beam deflected by the electromagnetic deflector 510 for separating the primary electron beam and the secondary electron beam from each other is deflected in a reverse direction by the electrostatic deflector 517. A magnified image is formed in an image point 518 of the chromatic aberration correction lens 519. A distance between the electrostatic deflector 517 and the image point 518 is designed to be ½ of a distance between the electromagnetic deflector 510 and the image point 518. A deflection angle produced by the electromagnetic deflector 510 and a deflection angle produced by the electrostatic deflector 517 are set such that directions thereof are reversed relative to each other, and absolute values thereof are equal to each other. Therefore, the chromatic aberration of deflection which is caused by the electromagnetic deflector 510 is corrected by the electrostatic deflector 517 to become zero. The magnified image of the secondary electron beam which is formed in the image point 518 passes through the chromatic aberration correction lens 519 and then is formed in the auxiliary lens 520. The chromatic aberration correction lens 519 produces the negative axial chromatic aberration in order to correct the positive axial chromatic aberration caused by the objective lens 560. The magnified image of the secondary electron beam which is formed in the auxiliary lens 520 is magnified by the magnifying lens 521 and then formed on the auxiliary lens 522. The image is further magnified by approximately 10 times by use of the final magnifying lens 523.

Therefore, an pixel image equal in size to an element of the TDI camera 504, is formed on the MCP 524 of the detection device 300. When the pixel size is to be changed, auxiliary lenses 530 and 531 for a large pixel are disposed instead of the auxiliary lens 522, and a magnified image is formed therein by the magnifying lens 521. Then, when a voltage is applied to an electrode of the auxiliary lens 530 or 531 to adjust magnification, the pixel image can be made equal in size to that on the TDI camera 504. As described above, the secondary electron image outputted from the MCP 524 is formed on the TDI camera 504. The TDI camera 504 converts the formed secondary electron image into an electrical signal.

The formed secondary electron image which is converted into the electrical signal by the TDI camera 504 of the detection device 300, is transmitted to the control device 500. The control device 500 can be constructed using a general-purpose computer. The computer includes a control unit 570 for executing various controls and arithmetic processes based on predetermined programs, a memory device 571 for storing the predetermined programs and the like, a display (CRT monitor) 573 for displaying process results, a secondary electron image 572, and the like, and an input unit 574 to which commands are inputted by an operator, using, for example, a keyboard or a mouse. The control device 500 may be constructed using hardware dedicated for a test device, a workstation, or the like.

As described above, according to the electron beam device in the second embodiment of the present invention, the electrode 514 of the objective lens 560 to which the high voltage is applied is formed to be cone shaped. The axially-symmetric electrode 515, to which the voltage substantially close to the ground voltage is applied, is provided on the sample W side. Therefore, the electric field formed by the electrode 514 to which the high voltage is applied is partially blocked by the axially-symmetric electrode 515. As a result, the electric field strength on the surface of the sample becomes smaller to prevent an electrical breakdown on the surface of the sample, so that discharge between the lens and the sample is prevented. The objective lens 560 includes the cone-shaped earth electrode 513 which is grounded in addition to the cone electrode 514 to which the high voltage is applied, so that the voltage applied to the cone electrode 514 required for constant lens action can be set to a relatively small value, and discharge between the lens and the sample is prevented. A finely adjusted voltage is applied from the voltage control power supply 400 to the axially-symmetric electrode 515 which is located on the sample surface side and substantially grounded, or adjusted voltages are applied to both the axially-symmetric electrode 515 and at least one cone-shaped electrode, to electrically control the axial chromatic aberration coefficient of the objective lens 560. Therefore, the absolute value of the positive axial chromatic aberration of the objective lens 560 is made equal to the absolute value of the negative axial chromatic aberration of the axial chromatic aberration correction lens 519 to perform canceling, so that residual chromatic aberration can be reduced to an extremely small value. Because the residual chromatic aberration is made smaller by the correction, the angular aperture of the NA aperture 512 can be set to a large value to increase a beam current of each beam, with the result that the sample can be evaluated at high throughput.

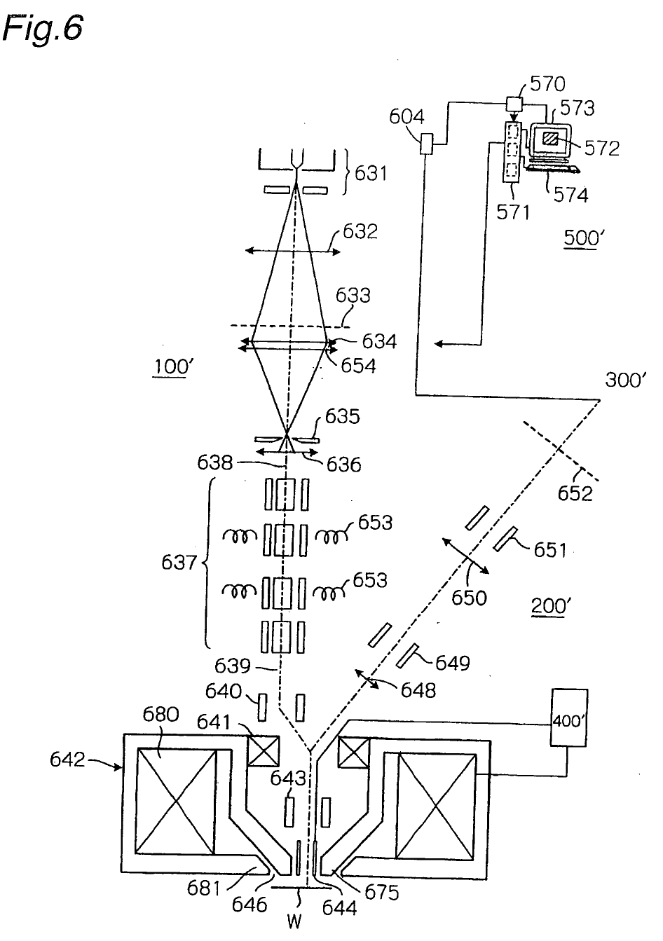

An electron beam device according to a third embodiment of the present invention will now be described with reference to FIG. 6. The electron beam device is a scanning electron microscope (SEM) type and includes a primary electron optical system 100′ for forming a multibeam from electrons emitted from an electron gun 631 and focusing the multibeam on the sample W to be scanned, a secondary electron optical system 200′ for magnifying an interval of secondary electron beams emitted from the sample W, a detection device 300′ for detecting secondary electrons injected from the secondary electron optical system, a voltage control power supply 400′, and a control device 500′. The control device 500′ is substantially the same as the control device 500 in the second embodiment as shown in FIG. 4.

The primary electron optical system 100′ includes the electron gun 631 having a LaB6 cathode for emitting primary electrons, a condenser lens 632 for focusing a primary electron beam emitted from the electron gun 631, a multi-aperture portion 633 for forming the multibeam from the focused primary electron beam, a shaping lens 634 and a reduction lens 636 which are used to reduce the multibeam and to image the reduced multibeam to a focal point 638, an NA aperture 635 for suppressing axial chromatic aberration to a low amount of aberration, a correction lens 654, a chromatic aberration correction lens 637 which causes negative axial chromatic aberration, an electrostatic deflector 640 for scanning the sample W with the multibeam and correcting the chromatic aberration of deflection which is caused by an electromagnetic deflector 641, and an objective lens 642. The primary electron optical system 100′ is constructed such that the multibeam is formed from the primary electrons emitted from the electron gun 631 having the LaB6 cathode, and focused on the sample W to be scanned by the electrostatic deflector 640.

The secondary-electron optical system 200′ includes magnifying lenses 648 and 650 for magnifying the second electron beams which are emitted from the sample W and accelerated by the objective lens 642 and electrostatic deflectors 649 and 651 for performing axis alignment of the secondary electron beams. In the secondary electron optical system 200′, the second electron beams emitted from the sample W are magnified and imaged to a detector 652.

The electromagnetic deflector 641 for electron beam separation can be included in the primary electron optical system 100′ or can be included in the secondary electron optical system 200′. Alternatively, the electromagnetic deflector 641 can be commonly included in both the primary electron optical system 100′ and the secondary electron optical system 200″.

The detection device 300′ includes the detector 652 and a signal processing circuit 604 having an A/D converter. The signal processing circuit 604 converts scanning electron microscope (SEM) images detected in a plurality of channels of the detector 652 into electronic signals and transmits the electronic signals as digital signals to the control device 500′.

In order to improve throughput, the SEM type electron beam device using the multibeam is required to form as many multi beams as possible on the sample W. Therefore, an irradiation region of the multi-aperture portion 633 is adjusted without changing a zoom action performed by the condenser lens 632 and the shaping lens 634, which are respectively disposed before and after the multi-aperture portion 633; that is, a focusing condition in which a crossover image formed by the electron gun 631 is formed in the NA aperture 635. When the shaping lens 634 is disposed in the rear of the multi-aperture portion 633, the shaping lens 634 can also serve as a rotation correction lens. Thus, the correction lens 654 is provided, and reversed axial magnetic fields are generated by the shaping lens 634 and the correction lens 654.

The chromatic aberration correction lens 637 includes four stages of quadrupole lenses and quadrupole correction magnetic field generating lenses 653 for aberration correction which are arranged in a direction in which positions in an azimuth angle direction are shifted by 45° relative to the electrodes of the quadrupole lenses. The chromatic aberration correction lens 637 causes negative axial chromatic aberration. The Wien filter as shown in FIG. 4 or 5 may be used as the chromatic aberration correction lens 637. It is preferable to correct not only the axial chromatic aberration but also the spherical aberration.

The objective lens 642 includes a magnetic field lens 680 having a circular coil whose center is located on an optical axis, a pipe-shaped cylindrical electrode 644 disposed along the center axis line (or the optical axis) of the magnetic field lens, an eight-pole scanning-deflector dynamic focus electrode 643, and a cone-shaped earth-potential magnetic pole 675, whose radius becomes smaller with a reduction in distance to the sample W. A magnetic gap 646 is formed on the sample W side and between an outer magnetic pole 681 and an inner magnetic pole 675. In order to focus the primary electron beam and reduce the axial chromatic aberration and the spherical aberration, the voltage control power supply 400′ supplies a positive high voltage to the cylindrical electrode 644. The magnetic poles 681 and 675 are continuously grounded. Therefore, even when the positive high voltage is applied to the cylindrical electrode 644, the electric field strength on the surface of the sample W can be suppressed to a small value.

The following is apparent from simulation. For example, in a case where a distance between the cylindrical electrode 644 and the sample W is 4 mm, and a voltage applied to the cylindrical electrode 644 is 8 kV, when the outside 675 is not the earth potential, an electric field of 2 kV/mm (=8 kV/4 mm) is applied to the surface of the sample W. However, when an outside potential is set to the each potential, the electric field is reduced to approximately 1.5 kV/mm. Therefore, an electrical breakdown on the surface of the sample is prevented, and discharge between the cylindrical electrode 644 and the sample W is prevented. Since the high voltage is applied to the cylindrical electrode 644, the axial chromatic aberration of the objective lens 642 is held to a small value.

In order to precisely make an absolute value of positive axial chromatic aberration caused by the objective lens 642 equal to an absolute value of negative axial chromatic aberration caused by the chromatic aberration correction lens 637, the voltage applied from the voltage control power supply 400′ to the objective lens 642 is adjusted as appropriate. That is, in order to increase the axial chromatic aberration of the objective lens 642, the voltage applied from the voltage control power supply 400′ to the cylindrical electrode 644 is preferably adjusted to a small value. In order to reduce the axial chromatic aberration, the voltage applied from the voltage control power supply 400′ to the cylindrical electrode 644 is preferably adjusted to a large value. Compensation for a deviation of the focusing condition which is caused by a change in voltage applied to the cylindrical electrode 644 is performed by adjusting an excitation current supplied from the voltage control power supply 400′ to the objective lens 644. In this embodiment, it is desirable to correct the spherical aberration using the Wien filter. However, the spherical aberration of the objective lens 642 having a structure in which the magnetic gap 646 is formed on the sample side is small, and therefore, even when an electromagnetic field applied to the Wien filter is small, the spherical aberration can be corrected.

The electrode 643 is an eight-pole electrode and a voltage close to the earth potential is applied to all the eight poles. Since the same voltage is applied to the eight poles, a focal length of the lens can be adjusted at high speed to perform dynamic focusing. When scanning signals are applied to the electrostatic deflector 640 for beam deflection and the eight-pole electrode 643, the sample W can be scanned with the multibeam. Since the entire residual aberration to be corrected is small, the angular aperture of the NA 635 can be set to a value equal to or larger than 100 mrad (milliradian) relative to a normal value of 10 mrad (milliradian). Thus, a large beam current can be obtained for each beam, so that the sample can be evaluated at high throughput.

The primary electrons emitted from the electron gun 631 including the LaB₆ cathode are focused by the condenser lens 632 to irradiate all apertures of the multi-aperture portion 633 at a uniform strength. The multibeam obtained by the multi-aperture portion 633 forms a reduction image at the focal point 638 by the shaping lens 634 and the reduction lens 636. The reduced image which has low abaxial aberration due to the provided NA 635 is formed in the position of a focal point 639 by the axial chromatic aberration correction lens 637. The image at the focal point 639 has negative axial chromatic aberration. The reduced image at the focal point 639 is further reduced by the objective lens 642 to form the multibeam on the sample W. The sample W is scanned with the multibeam by the electrostatic deflector 640 and the electrode 643. The positive axial chromatic aberration caused by the objective lens 642 is canceled by the negative axial chromatic aberration caused by the axial chromatic aberration correction lens 637.

The secondary electron beam emitted from the sample W is accelerated and focused by an accelerating electric field generated between the cylindrical electrode 644 provided in an inner portion of the objective lens 642 and the sample W. Then, the secondary electron beam is separated from the primary electron beam by the electromagnetic deflector 641 and enters the secondary electron optical system 200′ to be magnified in two steps by the magnifying lenses 648 and 650. The secondary electron beam is detected by the detector 652 to form SEM images in a plurality of channels. The electrostatic deflectors 649 and 651 are controlled such that a secondary electron signal corresponding to the same primary electron is always incident on the same detector 652 in synchronization with the scanning of the primary electron beam. The secondary electron images outputted from the detector 652 are sent to the signal processing circuit 604 having the A/D converter, and are converted into electrical signals. The electrical signals are processed by the control device 500′, as in the second embodiment.

As described above, according to the electron beam device in the third embodiment of the present invention, the high voltage is applied to the cylindrical electrode 644 of the objective lens 642, so that the axial chromatic aberration can be reduced to a small value. Since the magnetic pole 675 is in substantially a ground state, it is possible to prevent discharge between the cylindrical electrode 644 and the sample W, even when the high voltage is applied to the cylindrical electrode 644. The voltage applied to the cylindrical electrode 644 can be adjusted by the voltage control power supply 400′, so the absolute value of the positive axial chromatic aberration which is caused by the objective lens 642 can be made equal to the absolute value of the negative axial chromatic aberration which is caused by the chromatic aberration correction lens 37. Therefore, the axial chromatic aberration can be reliably corrected. As a result, the residual chromatic aberration is small, so the angular aperture can be set to a large value to increase a beam current of each beam. Thus, the sample can be evaluated at high throughput.

FIG. 7 shows a principal part of an electron beam device according to a fourth embodiment of the present invention. In the electron beam device, an irradiation region size and an irradiation current density of an electron beam emitted from an electron gun 71 are adjusted by two stages of condenser lenses 72 and 73. The electron beam is shaped through an aperture of an aperture portion 74, which is a rectangle such as a square in shape. A shaped rectangular electron beam travels to the sample W to be irradiated through two stages of shaping lenses 75 and 76, a beam separator 77, and an objective lens 79. In order to prevent the primary electron beam from affecting the secondary electron beam, a structure is employed in which a path of the primary electron beam is different from a path of the secondary electron beam even after the primary electron beam passes through the beam separator 77. Accordingly, an aperture portion 723 for the primary electron beam is provided.

Secondary electrons emitted from the sample W pass through an NA aperture 724 provided in an NA aperture portion 78 and are deflected by the beam separator 77. Then, the secondary electrons are deflected in a perpendicular direction by an aberration correction electrostatic deflector 711 and form a magnified image on a principal plane of an auxiliary lens 712. The secondary electron beam diverged from the auxiliary lens 712 passes through multiple stages of multipole axial chromatic aberration correction lenses 714 to 717 and images on a principal plane of an auxiliary lens 718 for a magnifying lens 719.

The magnified image formed on the principal plane of the auxiliary lens 712 forms an image in a position spaced apart from the optical axis. Therefore, when the secondary electron beam diverged from the auxiliary lens 712 is incident on the axial chromatic aberration correction lenses 714 to 717 without any change, large abaxial aberration occurs. In order to eliminate this problem, an image of the aperture portion 724 is formed by the auxiliary lens 712 in substantially a middle 718 of an optical axis direction of the axial chromatic aberration correction lenses 714 to 717.

The secondary electron image whose axial chromatic aberration is corrected, is magnified by a magnifying lens 719 to form a magnified image on a principal plane of an auxiliary lens 720. Then, the secondary electron image forms a final magnified image on a light receiving surface of an EBCCD detection unit 722 by a final magnifying lens 721 to detect the final magnified image by the EBCCD detection unit 722. A normal CCD detects light and outputs an electrical signal. In contrast to this, the EBCCD is a detector for detecting not light but an electron beam, and outputting an electrical signal. Reference numeral 713 denotes an axis alignment deflector for the axial chromatic aberration correction lenses 714 to 717.

A visual field on the sample W is divided into a plurality of square sub-visual fields which can be, for example, five sub-visual fields. The irradiation of the primary electron beam and the acquisition of image data based on a detected secondary electron beam are performed for each sub-visual field unit. Selection of the sub-visual fields is performed based on deflection control signals from a sub-visual field control unit 734, and the primary electron beam is deflected by two stages of deflectors 726 and 727 so as to travel on a path 732. It is to be noted that the path 732 is formed in a case where a sub-visual field located on the left side of the optical axis is irradiated. The secondary electrons emitted by the irradiation travels on a path 733. The sub-visual field control unit 734 is controlled by a CPU 728.

When the sub-visual field is distant from the optical axis, the secondary electron beam passes through the NA aperture 724 and only a beam traveling on the path 733 enters the secondary optical system. The sub-visual field control unit 734 supplies the deflection control signals to the beam separator 77 and the aberration correction electrostatic deflector 711. Therefore, the path of the secondary electron beam passing through the aberration correction electrostatic deflector 711 is corrected so that the path is aligned with the optical axis of the secondary optical system.

As shown in FIG. 8, the EBCCD detection unit 722 includes four EBCCD detectors 7221 to 7224, and the secondary electron image is deflected by a deflector 735 so as to be formed on the detectors in the order indicated by the arrows. Image data is taken from each of the EBCCDs through an electronic switch 740 controlled by the CPU 728. Exposure can be performed four times while the image data is taken from an EBCCD and stored in a corresponding memory. Therefore, the exposure can be performed without loss when a data taking time exceeds approximately four times the exposure time.

That is, when exposure to the EBCCD detector 7221 of the EBCCD detection unit 722 is completed, the image data starts to be taken from the detector and stored in a memory 741, and simultaneously, a next sub-visual field image is deflected so as to be formed to the EBCCD detector 7222. Then, exposure to the EBCCD detector 7222 starts after lapse of a set time. When the exposure to the EBCCD detector 7222 is completed after the lapse of the set time, the image data starts to be taken from the corresponding detector and stored in a memory 744, and an image is deflected to start exposure to the EBCCD detector 7223. Similarly, deflection, setting, and exposure are performed on each of the EBCCD detectors 7221 to 7224 in the order indicated by the arrows in FIG. 8, and data taking is performed. Therefore, in each of the EBCCD detectors, a time between the completion of exposure and the start of a next exposure becomes a sum of (exposure time×3) and (set time×4), which is nearly equal to exposure time×4. It is necessary to take data during this time. Thus, when a data taking time is equal to or shorter than approximately four times the period required for exposure, processing can be performed without time loss.

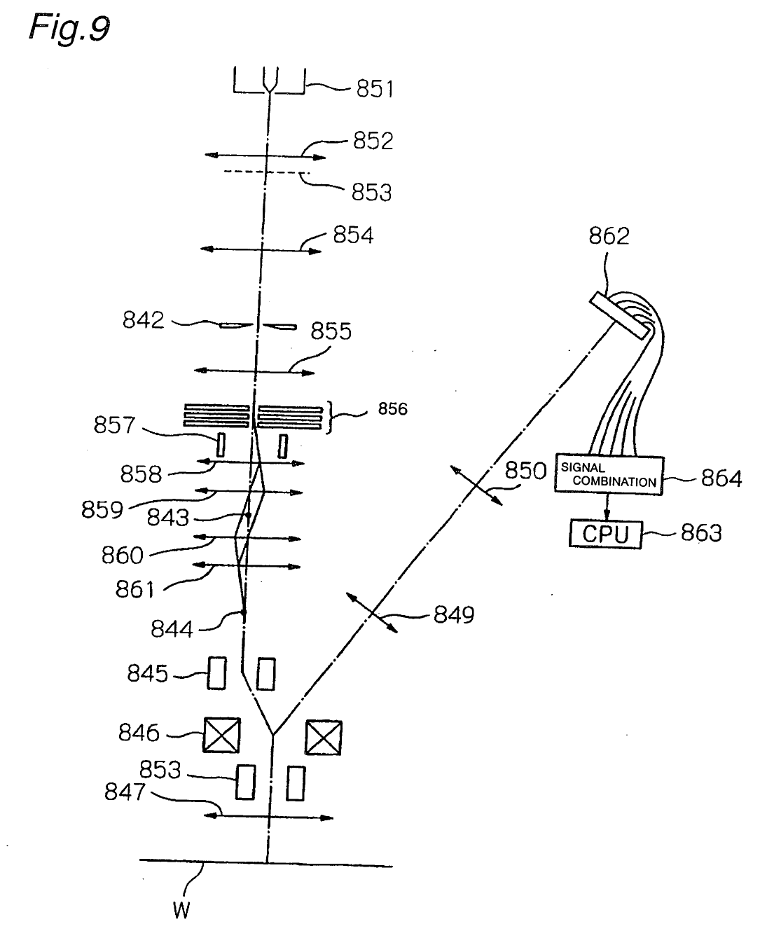

FIG. 9 shows a principal part of an electron beam device according to a fifth embodiment of the present invention. In the electron beam device according to this embodiment, an electron beam emitted from an electron gun 851 is focused by a condenser-lens 852 to irradiate a multi-aperture portion 853, thereby forming a multibeam. The sample W is irradiated with the multibeam through reduction lenses 854 and 855 and an objective lens 847. At this time, the multibeam is deflected to scan the sample W by electrostatic deflectors 845 and 853.

In the electron beam device according to the fifth embodiment, an auxiliary lens 856 is provided in an imaging position of the reduction lens 855, and axial chromatic aberration correction lenses 858 to 861 including four stages of quadrupole lenses are disposed on a downstream side. The multibeam is spread in the image position of the reduction lens 855 in a range of a distance of approximately 20 μm from the optical axis, so that the axial chromatic aberration correction lenses 858 to 861 cause abaxial aberration. The abaxial aberration can be reduced by forming an image of an NA aperture 842 in a middle 843 of the axial chromatic aberration correction lenses 814 to 817 by the auxiliary lens 856. As a result, an eight-column eight-row multibeam can be obtained in which each of the beams has an intensity of 6.25 nA and a beam diameter of 25 nm. This is obtained by simulation of the electron optical system having the above-mentioned structure.

The secondary electrons emitted from the sample W are accelerated by the objective lens 847 and separated from the primary electron beams by a beam separator 846 to travel to the secondary optical system. In the secondary optical system, the secondary electron beams are magnified by two stages of magnifying lenses 849 and 850 and then projected to and detected by a detection-unit 862. The detection unit 862 includes a plurality of detectors corresponding to the number of secondary electron beams of the multibeam. In order to make an arrangement pitch of the detectors equal to a pitch of secondary electron images on a principal plane of the detection unit 862, a zoom action is performed by the lenses 849 and 850.

In FIG. 9, reference numeral 863 denotes a CPU for controlling the operation of the entire electron beam device. A signal obtained by each of the detectors of the detection unit 862 is stored in a memory (not shown) under control of the CPU 863.

The CPU 863 has a function for evaluating a beam interval of the primary electron beams of the multibeam and an angle (rotational angle) θ between the beam arrangement direction and an x-y coordinate axis. Hereinafter, the function will be described with reference to an example in which a four-column four-row multibeam is used.

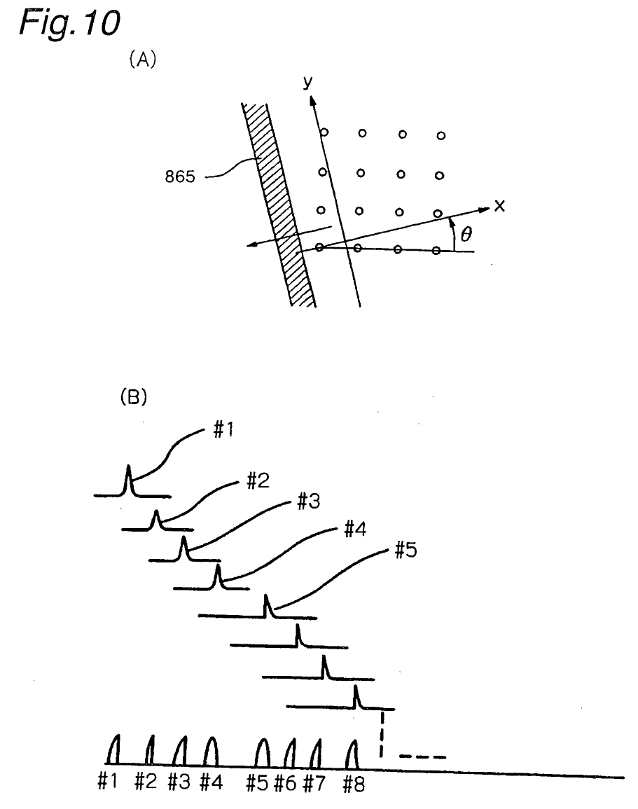

In order to execute this function, a signal combination unit 864 for combining the signals from the plurality of detectors is provided in the electron beam device, and a signal from the signal combination unit 864 is supplied to the CPU 863. As shown in FIG. 10(A), a pattern 865 parallel to a y-axis (stage continuous moving direction) of the x-y coordinate system corresponding to reference coordinates of the electron beam device is provided on a sample for testing. The sample is irradiated with a multibeam to be scanned such that a multibeam scan direction is orthogonal to an x-axis direction, that is, the pattern 865.

Accordingly, as shown in FIG. 10(B), a signal, which attains a high level each time the pattern 865 is irradiated with an electron beam, is obtained from each of the plurality of detectors included in the detection unit 862. A signal obtained by a signal combination (lowest side in FIG. 10(B)) is supplied from the signal combination unit 864 to the CPU 863. Of signals to be combined, first to fourth signals #1-#4 are obtained by irradiating the pattern 865 with four electron beams located in a first column of the multibeam. Fifth to eighth signals #5-#8, ninth to twelfth signals #9-#12, and thirteenth to sixteenth signals #13-#16 are obtained by irradiating the pattern 865 with electron beams located in a second column, a third column, and a fourth column of the multibeam, respectively.

The CPU 863 determines whether or not the rotational angle θ is adequate based on a detected time interval between the signals. That is, in the case of the four-column four-row multibeam, when the rotational angle θ is inadequate, an interval between the fourth and fifth signals #4 and #5 is different from an interval between the first and second signals #1 and #2 (or second and third signals #2 and #3, or third and fourth signals #3 and #4). When an interval between fourth and fifth signals #4 and #5 is larger than other signal intervals, it is apparent that the rotational angle θ is too small. In contrast, when the former signal interval is smaller, this exhibits that the rotational angle θ is too large.

The CPU 863 detects a period of signals outputted from the respective detectors, that is, a time interval, and compares signal time intervals with each other to determine whether the interval between the fourth and fifth signal is larger than or smaller than the other signal interval. Then, the CPU 863 generates an output for reducing or increasing the rotational angle based on a result obtained by the comparison. When the multi-aperture portion 853 is finely rotated or when the lenses 854 and 855 are finely rotated as rotating lenses, the rotational angle θ can be adjusted such that the signal time internals are equal to one another.

After the rotational angle θ is adjusted to make the signal intervals equal to one another, the CPU 863 evaluates whether the beam interval is equal to a predetermined value, that is, whether a raster interval is equal to a pixel size or an integral multiple of the pixel size. This evaluation can be executed by detecting an interval between the first and fourth signals, dividing the interval by three, and comparing a value obtained by division with the predetermined value. If an interval between adjacent signals is used for evaluation, it is likely to include an error. However, high-precision evaluation can be performed by carrying out the above-mentioned operation. Alternatively, an interval from the first signal to the sixteenth signal can be detected and divided by 15, and then the resultant value is compared with the predetermined value. By this method, a higher precision evaluation can be performed.

An interval from the second signal to the fifteenth signal can be detected and divided by 13 to compare the predetermined value. In general, distortion caused by the primary optical system appears in four corner beams of the multibeam having a matrix arrangement. However, even when the distortion is caused by the primary optical system, the beam interval can be evaluated with high precision, using the above interval evaluation method.

When the beam interval is different from the predetermined value, the beam interval can be made equal to the value by adjusting the reduction ratio of the primary electron optical system.

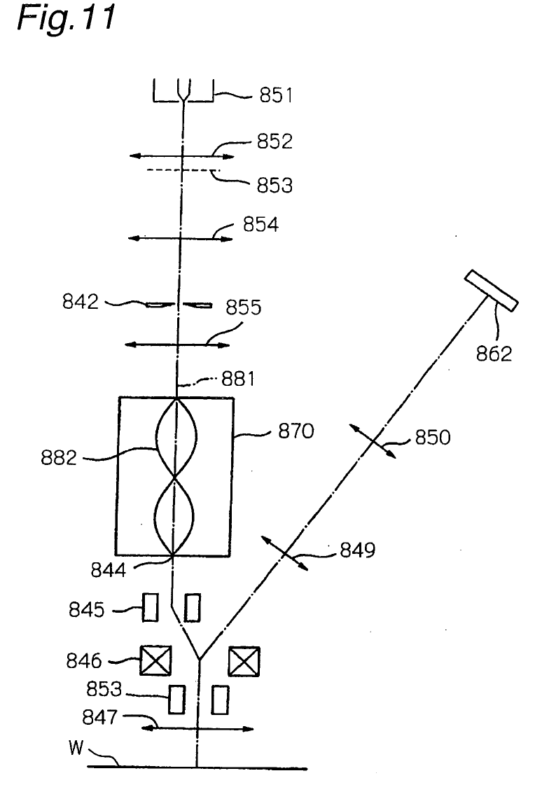

FIG. 11 shows a principal part of an electron beam device according to a sixth embodiment of the present invention. In the electron beam device according to the sixth embodiment, a Wien filter 870 is used instead of the auxiliary lens 858, an axis alignment lens 857, and the quadrupole lenses 858 to 861 in the fifth embodiment shown in FIG. 9. Even in the case of the electron beam device according to the sixth embodiment, an increase in aberration caused by a wide visual field can be prevented. The Wien filter 870 can be set as a non-dispersion type by two-time focusing, as indicated by the path 882 in FIG. 11.

Even in the case of the electron beam device according to the sixth embodiment, the angle θ between the multibeam arrangement direction and the x-y coordinate system and the beam interval can be adjusted, using the method as described with reference to FIGS. 10A and 10B.

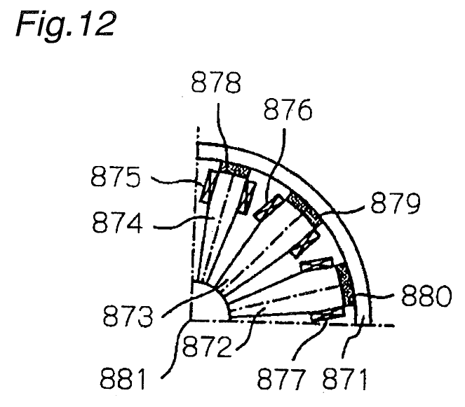

FIG. 12 shows a ¼ cross sectional shape of the Wien filter 870 with an optical axis 881 as the center in the embodiment shown in FIG. 6. The Wien filter 870 includes a cylindrical-shaped yoke 871 made of a permalloy, dodecapole electrodes (also serving as magnetic poles) 872 to 874 made of a permalloy, coils 875 to 877 for generating correction magnetic fields, and spacers 878 to 880 for insulating the respective electrodes from one another. When voltages applied to the dodecapole electrodes 872 to 874 are adjusted to generate an electric field, a magnetic field, a quadrupole electromagnetic field for chromatic aberration correction, and a sextupole electromagnetic field for spherical aberration correction which satisfy the Wien condition, the axial chromatic aberration and the spherical aberration can be corrected.

In the electron beam device according to each of the fourth to sixth embodiments, since the auxiliary lens is provided on the image plane located on the incident side of the axial chromatic aberration correction lens, the abaxial aberration caused by the axial chromatic aberration correction lens can be reduced. Therefore, it is possible to obtain high-precision image data having reduced aberration.

According to the multibeam type electron beam device, it can be evaluated whether the angle formed between the beam arrangement direction and the reference coordinate axis is adequate, and whether the beam interval is equal to the predetermined value on the basis of the interval between the obtained signals, so that the angle and the beam interval can be precisely adjusted.

1. An electron beam device for irradiating a sample with an electron beam and detecting electrons emitted from the sample to obtain information on the sample, comprising:
multiple stages of multipole lenses; and
an auxiliary lens located on an incident side of the multiple stages of multipole lenses, an image plane being formed in an inner surface of the auxiliary lens.

2. An electron beam device according to claim 1, wherein
the electron beam device is adapted to perform that irradiation of a primary electron beam and detection of a secondary electron beam are repeatedly carried out for each of a plurality of sub-visual fields which are defined by dividing a visual field, and
the electron beam device comprises an axial chromatic aberration correction lens which is included in a magnifying optical system of a secondary optical system of the electron beam device.

3. An electron beam device according to claim 1 or 2, further comprising:
means for shaping a primary electron beam into a rectangular beam, which is included in a primary electron optical system of the electron beam device.

4. An electron beam device according to claim 1, further comprising:
means for irradiating the sample with a primary electron beam as a multibeam, which is included in a primary electron optical system of the electron beam device;
detecting means comprising a plurality of detectors for detecting a plurality of secondary electron beams containing the electrons emitted from the sample; and
multibeam evaluation means for evaluating a rotational angle between an arrangement direction of the multibeam and a reference coordinate system of the electron beam device, and a beam interval of the multibeam.

5. An electron beam device according to claim 4, wherein an axial chromatic aberration correction lens and the auxiliary lens are included in the primary electron optical system.

6. An electron beam device according to claim 4 or 5, wherein the multibeam evaluation means is adapted to perform the evaluations on the basis of time intervals between signals obtained by the plurality of detectors when markers provided parallel to a y-axis of the reference coordinate-system are scanned in an x-axis direction, the y-axis being a stage continuous moving direction.
